(19) United States
(12) Patent Application Publication
(10) Pub. No.: US 2026/0366443 A1
(43) Pub. Date: Nov. 19, 2026

(54) SEAL ASSEMBLY BETWEEN COALESCING FILTER AND HOUSING

(71) Applicant: Caterpillar Inc., Peoria, IL (US)

(72) Inventors: Rodney Allen Lawrence, Frankfort, IN (US); Lucas K. Smith, Lafayette, IN (US); Brandyn A. Stack, Lafayette, IN (US)

(73) Assignee: Caterpillar Inc., Peoria, IL (US)

(21) Appl. No.: 19/212,468

(22) Filed: May 19, 2025

(51) Int. Cl. F01M 13/04; B01D 46/00

(52) U.S. Cl. CPC F01M 13/04; B01D 46/003; B01D 2201/291; B01D 2201/304; F01M 2013/0438

(57) ABSTRACT

An apparatus may include a housing forming an inner cavity. An apparatus may include a coalescing filter having a first end and a second end, wherein the coalescing filter is received within the inner cavity and configured to separate the oil from the blow-by gas. An apparatus may include a baffle coupled to the housing within the inner cavity, wherein the baffle engages an exterior surface of the coalescing filter at a first distance between the first end and the second end to form a seal assembly therewith.

### TECHNICAL FIELD

The present disclosure relates to crankcase ventilation systems for internal combustion engines such as those for vehicles or stationary power generation. More particularly, the present disclosure relates to oil separating devices for crankcase ventilation systems that include a seal assembly between a coalescing filter and a housing.

### BACKGROUND

Machinery, for example, agricultural, industrial, construction or other heavy machinery can be propelled by an internal combustion engine(s). Internal combustion engines can be used for other purposes such as for power generation. Internal combustion engines combust a mixture of air and fuel in cylinders and thereby produce drive torque and power. A portion of the combustion gases (termed “blow-by” gas) may escape the combustion chamber past the piston and enter undesirable areas of the engine such as the crankcase. Blow-by gas can contain un-combusted fuel, oil and explosive gases. In rare cases, un-combusted fuel and/or explosive gases can build within the engine such as within the crankcase. The un-combusted fuel and/or explosive gases can result in an explosion if not properly mitigated such as by a relief valve. Crankcase ventilation systems are known in combustion engines to vent, capture or dilute blow-by gases of the crankcase. Such ventilation systems can include oil separation devices as part of such systems. For example, United States Patent Application Publication Nos. 20180304179A1 and 20090152189A1 and U.S. Pat. No. 11,707,703B2 disclose examples of an oil separation devices with various configurations. However, these patent applications and patent do not recognize various features and components of the present application including the disclosed seal assemblies.

### SUMMARY

In an example according to this disclosure, an apparatus for separating oil from a blow-by gas of an engine, including: a housing forming an inner cavity; a coalescing filter having a first end and a second end, wherein the coalescing filter is received within the inner cavity and configured to separate the oil from the blow-by gas; and a baffle coupled to the housing within the inner cavity, wherein the baffle engages an exterior surface of the coalescing filter at a first distance between the first end and the second end to form a seal assembly therewith.

In another example according to this disclosure, an engine system including: an engine; and an oil separating apparatus, including: a housing forming an inner cavity; a coalescing filter having a first end and a second end, wherein the coalescing filter is configured to be insertable to be received within the inner cavity and is configured to separate oil from a blow-by gas; a baffle configured to be positioned in the housing within the inner cavity, wherein the baffle is configured to engage an exterior surface of the coalescing filter at a first distance between the first end and the second end to form a seal assembly therewith; a first one or more fluid lines passing the blow-by gas from the engine to the oil separating apparatus; and a second one or more fluid lines passing the blow-by gas from the oil separating apparatus back to the engine.

In yet another example according to this disclosure, a method of preventing bypass flow in an apparatus for separating oil from a blow-by gas of an engine, including: positioning a baffle within a housing of the apparatus; inserting a coalescing filter into the housing; engaging the baffle along a perimeter of the coalescing filter to form a seal assembly therebetween; and draining coalesced oil as a weep through a plurality of holes in an end cap of the coalescing filter, wherein the plurality of holes are positioned between the baffle and a sealant that bonds the end cap to an end of a filter media.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is schematic illustration depicting an example internal combustion engine with a closed crankcase ventilation system including a blow-by gas oil separation device in accordance with an example of the present application.

FIG. 2 is a schematic illustration of further aspects and components of the closed crankcase ventilation system of FIG. 1.

FIG. 3 is schematic illustration of the closed crankcase ventilation system of FIGS. 1 and 2 depicting what may happen if an oil drain sub-system failure occurs when raw blow-by is drawn up an oil drain line, bypasses the coalescing filter element, and mixes with filtered blow-by shown in FIG. 2 in accordance with an example of the present application.

FIG. 4 is a perspective view of the oil separation device according to one example of the present application.

FIG. 5 is an exploded view of components of the oil separation device of FIG. 4.

FIG. 6 is a perspective view of an outer housing of the oil separation device of FIGS. 4 and 5 according to an example of the present application.

FIG. 7 is a perspective view of an inlet manifold of the oil separation device of FIGS. 4 and 5 according to an example of the present application.

FIG. 8 is a cross-sectional view of the lower filter support of the inlet manifold engaging with a lower end cap of the coalescing filter according to an example of the present application.

FIG. 9 is a perspective view of a portion of the coalescing filter showing the lower end cap according to an example of the present application.

FIG. 10 is a cross-sectional view of the oil separation device of FIGS. 4 and 5.

FIG. 11 is an enlarged cross-sectional view of a portion of the oil separation device including a portion of the coalescing filter of FIG. 10 illustrating a baffle that forms part of a seal assembly according to an example of the present application.

FIG. 12 is a further enlarged cross-sectional view of the portion of the oil separation device including the portion of the coalescing filter of FIGS. 10 and 11 further illustrating aspects of the baffle and the seal assembly.

FIG. 13 is a cross-sectional view of a lower portion of the coalescing filter and a portion of the housing of FIGS. 10-12 further illustrating aspects of the baffle and seal assembly.

FIGS. 14-19 are enlarged cross-sectional views of various alternative example configurations for baffles and seal assemblies created by interaction of the baffle with alternative designs for coalescing filter.

FIG. 20 illustrates a coalescing filter removed from and about be inserted into the housing of the oil separation device with the housing containing the baffle according to an example of the present application.

FIG. 21 illustrates a method of preventing bypass flow in an apparatus for separating oil from a blow-by gas of an engine according to an example of the present application.

### DETAILED DESCRIPTION

Examples according to this disclosure are directed to an oil separation device and assemblies of multiple oil separation devices for internal combustion engines, and to systems and methods for filtering oil to separate oil and other forms of particulate matter from blow-by gas. Examples of the present disclosure are now described with reference to the accompanying drawings. The following description is merely exemplary in nature and is not intended to limit the present disclosure, application, or use. Examples described set forth specific components, devices, and methods, to provide an understanding of embodiments of the present disclosure. It will be apparent to those skilled in the art that specific details need not be employed and that examples may be embodied in many different forms. Thus, the examples provided should not be construed to limit the scope of the claims.

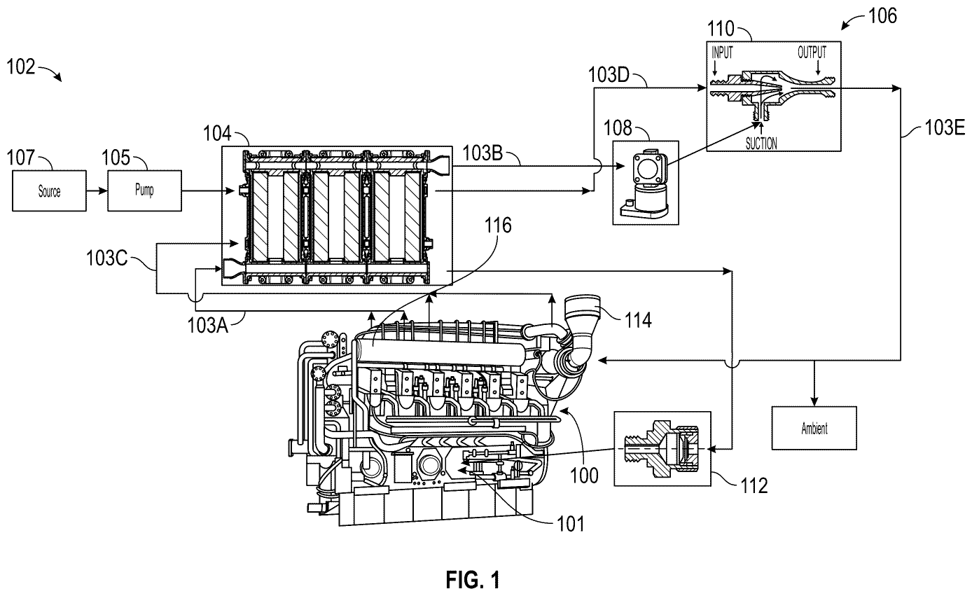

FIG. 1 depicts an example schematic illustration of an engine 100 in accordance with this disclosure. The engine 100 can be used for power generation such as for the propulsion of vehicles or other machinery. The engine 100 can include various power generation platforms, including, for example, an internal combustion engine, whether gasoline, natural gas, dynamic gas blending, or diesel. It is understood that the present disclosure can apply to any number of piston-cylinder arrangements and a variety of engine configurations including, but not limited to, V-engines, inline engines, and horizontally opposed engines, as well as overhead cam and cam-in-block configurations.

In some applications, the internal combustion engines disclosed here are contemplated for use in gas compression. Thus, the internal combustion engines can be used in stationary applications in some examples. In other applications the internal combustion engines disclosed can be used with vehicles and machinery that include those related to various industries, including, as examples, oil exploration, construction, agriculture, forestry, transportation, material handling, waste management, etc.

The engine 100 can include a system 102 with at least one oil separation device 104 (or an array of a plurality of oil separation devices 104 as shown). The system 102 can include auxiliary components 106 to the engine 100 such as a regulator 108, jet pump 110 and a check valve 112. The check valve 112 can be placed, for example, at the bottom of the oil drain sub-system to prevent unfiltered blow-by gas from bypassing a coalescing filter of the oil separation device 104 and passing directly to a compressor 114. Thus, the check valve 112 can regulate the flow of oil.

In the example of FIG. 1, the system 102 can be part of the original manufacture of the engine 100 or can be a retrofitted system that is added to the engine 100 during maintenance, upgrade or the like. As will be discussed in further detail subsequently, the system 102 can use the oil separation device(s) 104 to filter oil from the blow-by gas to reduce volatile content in the blow-by gas.

The system 102 can be part of a purge system, which can be in fluid communication with a crankcase 101 of the engine 100 such as via an inlet passageway. The system 102 can be configured to supply air to the crankcase and through the engine block or through other components (not shown) to a cylinder head of the engine 100. The air the system 102 supplies can act to ventilate the crankcase 101 and other components of the engine 100 such as the cylinder head, the rocker box, etc. This ventilation, in addition to operation of the oil separation device(s) 104 to separate oil from the blow-by gas, can dilute un-combusted fuel, explosive gases and/or volatiles below a lower explosive limit so as to prevent or reduce the likelihood of an explosion within the engine 100.

The system 102 can include connected passages (some specifically illustrated by arrows and numbered in FIG. 1) that are in fluid communication with various components of the system 102. Some components of the engine 100 such as the engine block, the crankcase 101, the cylinder head, the rocker box, the valve cover and/or the breather can be in fluid communication. The terms “passage”, “passages”, “passageway”, “passageways”, “line” or “lines” as used herein should be interpreted broadly. These terms can be features defined by the various components of the engine illustrated in the FIGURES or can be formed by additional components (e.g., a hose, tube, pipe, manifold, cavity etc.) as known in the art. These additional components can be external to the engine 100 in some examples. Passageways can also connect the regulator 108, the jet pump 110 and the check valve 112 with selected parts of the oil separation device(s) 104 as further described herein.

The system 102 can include passages and other components such as those shown in FIG. 1. Dirty blow-by gas containing oil and volatiles of the system 102 can pass along a passage 103A from a breather or other device of the engine 100 and can pass to the oil separation device(s) 104 for filtering of oil to reduce volatile content of the blow-by gas. The blow-by gas, after filtering of the oil, can pass from the oil separation device(s) 104 along passage 103B to the regulator 108 (e.g., a vacuum control valve, mechanical valve or similar regulating device) located between the oil separation device(s) 104 and the jet pump 110. The blow-by gas can pass from the regulator 108 to the suction of the jet pump 110. The regulator 108 (e.g., the vacuum control valve) can be in fluid communication with the blow-by gas. The regulator 108 can be configured to regulate a flow of the blow-by gas to control a vacuum of the jet pump 110.

In tandem with the blow-by gas, the system 102 can utilize boost air from the compressor 114 (or other component such as a turbocharger) and/or air from an aftercooler 116, which moves along passage 103C. This boost air can be mixed in a desired ratio and passed through one or more jackets of the oil separation device(s) 104. Such arrangement can keep the filter of each of the oil separation device(s) 104 at between about 80 degrees Celsius and 120 degrees Celsius, for example. The boost air can be mixed to achieve a temperature range above the dew point temperature of the blow-by gas and below a temperature at which one or more components of the oil separating apparatus become inoperable (fail due to melting or other modality). However, other examples contemplate the use of alternative fluids, fluid temperatures and/or other configurations for the system 102. For example, the system 102 can utilize another fluid such as engine coolant or engine lube oil can be circulated by a pump 105 from a source 107 to the jacket of the oil separating apparatus 104.

After leaving the jacket(s), the boost air, now at a reduced pressure and temperature from a pressure and temperature leaving the engine 100, can pass along passage 103D to an input of the jet pump 110. The jet pump 110 can use the boost air as motive air for drawing the blow-by gas through the oil separation device(s) 104. The blow-by gas after leaving the oil separation device(s) 104 can be routed to a suction port of the jet pump 110. The boost air can be routed to an inlet port of the jet pump 110. The blow-by gas and the boost air can be combined in the jet pump 110. In particular, jet pump 110 can be configured to pass the blow-by gas and the boost air through a venturi of the jet pump 110. Some or all of the combined motive air and blow-by gas can pass along passage 103E to be returned to the engine 100, for example as an inlet to the compressor 114. Some or all of the combined motive air and blow-by gas can also be routed to ambient. The air can pass to the compressor 114, which can be configured to receive and compress the air. The compressed air can pass from the compressor 114 to the aftercooler 116. Thus, the aftercooler 116 can be in fluid communication with the compressor 114. The aftercooler 116 can be configured to receive and cool at least a portion of the compressed air.

To briefly summarize, the crankcase 101 can have a blow-by gas passing therethrough. The oil separation device(s) 104 can be in fluid communication with the blow-by gas and configured to separate oil from the blow-by gas. A mass flow rate of the boost air can be between 0.5% and 2.5% of a mass flow rate of the air received by the compressor 114. The boost air can be passed through the oil separation device(s) 104 in a heat exchange relationship with the blow-by gas to maintain a temperature of the blow-by gas within the oil separation device(s) 104 at a desired temperature range. The system 102 can include the jet pump 110 can be in fluid communication with both the blow-by gas after leaving the oil separation device(s) 104 and the boost air after leaving the oil separation device(s) 104. The jet pump can be configured to combine the blow-by gas and the boost air. After leaving the jet pump, the combined blow-by gas and the boost air can be routed to at least one of the compressor 114 or ambient.

Put another way, the system 102 can be configured to ratio compressor outlet boost air with aftercooler output air. This ratio of air can target a temperature somewhere between 80 degree Celsius to 120 degrees Celsius. Thus, the compressed air from the compressor 114 and cooled air from the aftercooler 116 can be mixed to achieve boost air at a temperature range of between 80 °C and 120 °C, inclusive. This mixture of air can be fed to the jacket of each of the oil separation device(s) 104 the keep the filter of each of the oil separation device(s) 104 at between about 80 degrees Celsius and 120 degrees Celsius, for example. This mixture of air, after passing through the jacket of the oil separation device(s) 104, can be fed to the jet pump 110 as motive air. Passage of the motive air through the jet pump 110 can create a vacuum that can be modulated by the regulator 108 (e.g., vacuum control valve or a mechanical valve). The regulator 108 can modulate the vacuum at the outlet of the system 102 and can regulate crankcase pressure (via flow of blow-by gas to the suction of the jet pump 110). Additionally, the filter(s) of the oil separation device(s) 104 is heated, cooled or maintained at a desired temperature using the boost air.

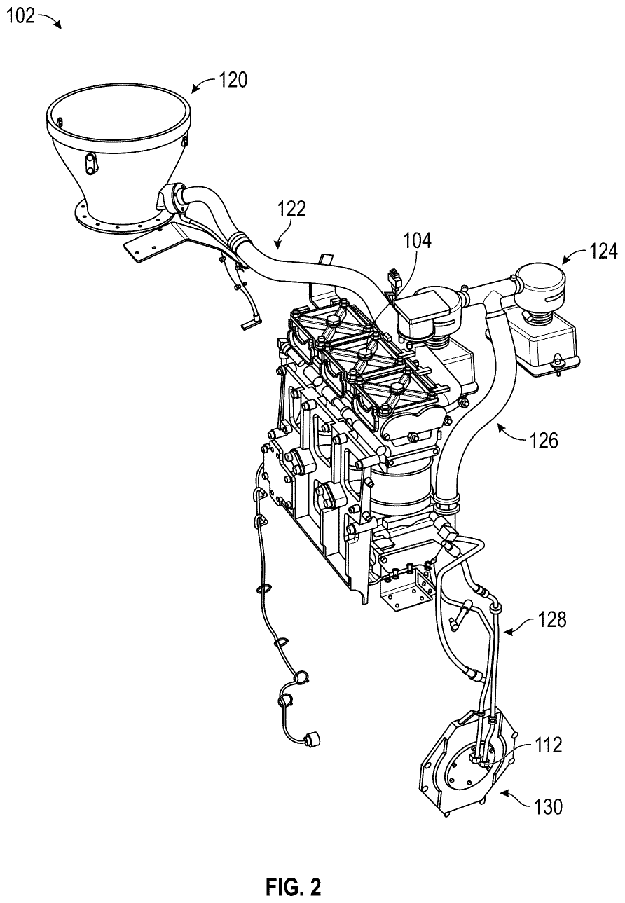

FIG. 2 shows some components of the system 102 including the oil separation devices 104 and the check valve 112 discussed previously. FIG. 2 additionally shows an engine filtered air inlet 120, a blow-by outlet line 122, crankcase breathers 124, blow-by inlet line 126, oil drain line(s) 128 and a crankcase side cover 130.

FIG. 2 shows an arrangement where the blow-by inlet line 126 is coupled to a first (lower) side the oil separation devices 104 to allow unfiltered blow-by gas leaving the crankcase breathers 124 to enter the oil separation devices 104. The oil separation devices 104 are configured to pass the blow-by gas from the first (lower) side to a second (upper) side and are configured to filter oil such as by coalescing the oil with a filter from the blow-by gas. The filtered blow-by gas can pass from the oil separation devices 104 to the blow-by outlet line 122 and on to ambient or are put to other uses as discussed in FIG. 1. The coalesced oil can pass from the oil separation devices 104 back to the engine via the drain line(s) 128, the check valve 112 and the crankcase side cover 130, for example.

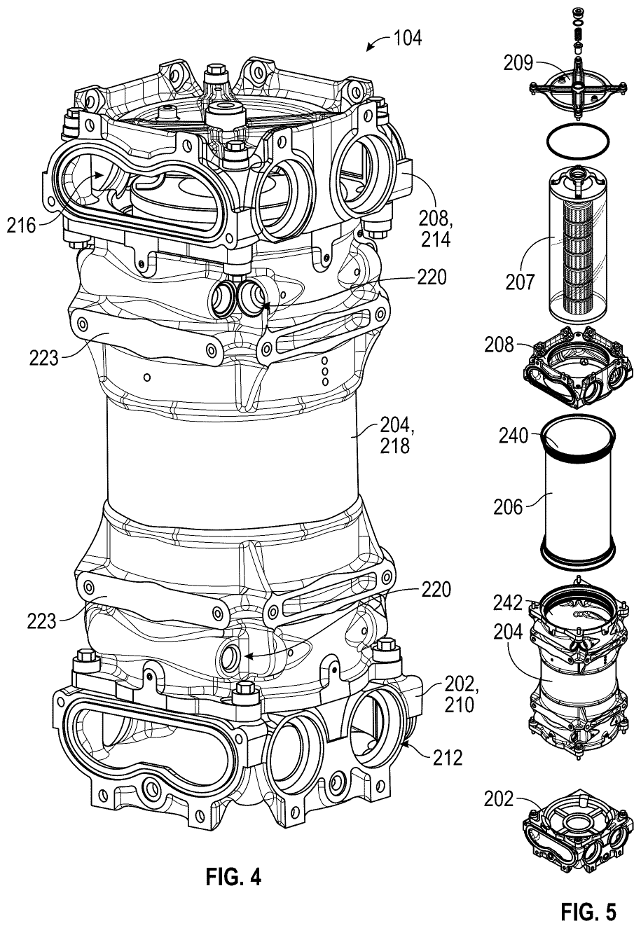

FIG. 4 shows an example of the oil separation device 104 that can be used with the system 102 described previously. FIG. 5 shows an exploded view of components of the oil separation device 104. As shown in FIG. 5, the oil separation device 104 can include an inlet manifold 202, an outer housing 204, an inner housing 206, a coalescing filter 207, an outlet manifold 208 and a cover 209.

Referring now to FIG. 4, the inlet manifold 202 can include a main body 210 and one or more ports 212. As shown in FIG. 4, the outlet manifold 208 can include a main body 214 and one or more ports 216. Selective of the one or more ports 212 and/or one or more ports 216 can be blocked from receiving or outleting blow-by gas with a cover, plug, plate or other feature to close the respective port according to some examples.

As shown in FIG. 4, the inlet manifold 202 can be connected to a first end portion of the outer housing 204 by fastener, weld, solder, threading or other mechanical connection as known in the art. Similarly, the outlet manifold 208 can be connected to a second end portion of the outer housing 204 in a similar manner to the inlet manifold 202. The second end portion can generally oppose the first end portion.

The inlet manifold 202 and/or the outlet manifold 208 can be part of the outer housing 204 according to further examples rather than being a separate component. For example, the outer housing 204, the inlet manifold 202 and/or the outlet manifold 208 could comprise an integral single piece assembly according to some examples. The present application can refer to the inlet manifold 202 and the outlet manifold 208, the cover and other components as a “housing” for simplicity herein with the understanding that the term housing as used herein broadly refers to not just the inner housing 206 and outer housing 204 but also the inlet manifold 202, the outlet manifold 208, the cover 209 and/or other components that are not the coalescing filter 207. Similarly, terms like “upper”, “lower”, “top”, “bottom” are relative terms not absolute terms. The orientation of the oil separation device 104 can vary from the exemplary orientation illustrated.

The inlet manifold 202 and the outlet manifold 208 can have a square, rectangular, circular, pentagon, quadrilateral, hexagon, octagon, or other shape in cross-section as desired and can be constructed of any suitable material(s). The main body 210 can form exterior walls, faces, one or more manifolds and other features of the inlet manifold 202. In brief, the main body 210 can be configured to form the one or more ports 212 for communication of blow-by gas into or out of the oil separation device 104. Although not specifically shown, an insulative material can abut or be in close proximity to and extend over one or more sides of the main body 210 such as at an end thereof. The insulative material can be held in place with mechanical fasteners, a plate and/or other feature or components. According to one example, the insulative material can be a fiberglass insulation encapsulated within a stainless steel foil, or a steel outer shell with an integral foam insulative underlayer.

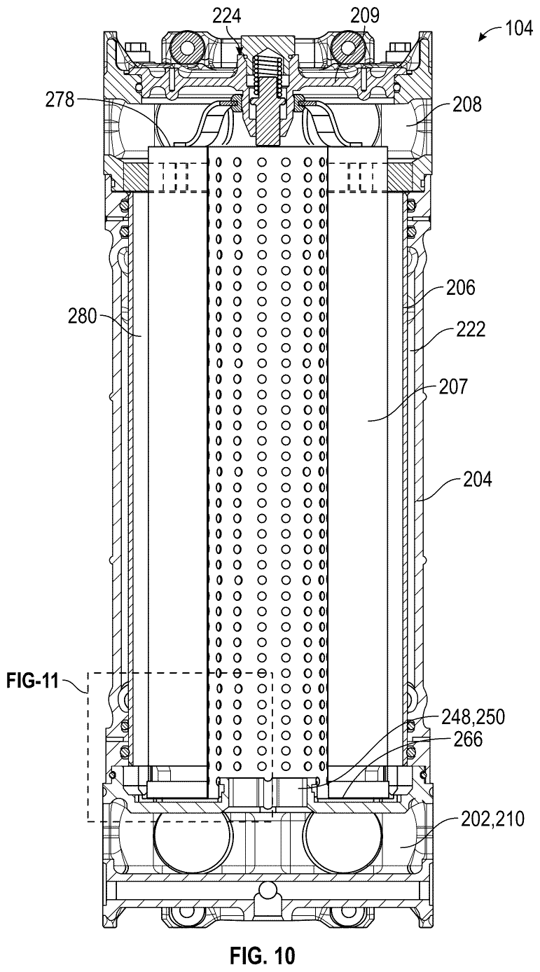

The outer housing 204 can have a hollow tubular shape, for example. This shape can form an inner cavity configured to receive the inner housing 206. Thus, the inner housing 206 can be positioned within the outer housing 204. The inner housing 206 and the outer housing 204 can be constructed of suitable material(s). Although the outer housing 204 and the inner housing 206 are illustrated as separate components in the FIGURES, it is contemplated in some examples that these could be integrally formed as a single piece such as by casting or another forming technique. Referring to FIG. 4, the outer housing 204 can form a wall 218 with ports 220 passing through the wall 218. These ports 220 can provide inlet(s) or outlet(s) as desired and can be in fluid communication with a jacket 222 (discussed and illustrated further in FIG. 10). The ports 220 can be located at specifically configured flanges 223 or other features of the outer housing 204. The flanges 223 can form different faces of the outer housing 204. These faces of the outer housing 204 can correspond with faces of the inlet manifold 202 and/or the outlet manifold 208, for example.

The main body 214 can form exterior walls, faces, one or more manifolds and other features of the outlet manifold 208. The main body 214 can be configured to form the one or more ports 216 for communication of blow-by gas into or out of the oil separation device 104. The cover 209 can be configured to couple with the main body 214 and can be selectively removable therefrom. The cover 209 can allow access to an inner cavity (formed by the inner housing 206) and the coalescing filter 207. The coalescing filter 207 can be removed and changed for a new filter with selective removal of the cover 209 from the main body 214. This process is further illustrated and described in FIG. 22. An insulative material can abut or be in close proximity to and extend over one or more sides of the main body 214 and the cover 209. The insulative material can be held in place with mechanical fasteners, a plate and/or other features or components in a manner similar to that if the insulative material of the inlet manifold 202.

The cover 209 (FIG. 5) can be constructed of suitable material(s) such as metal or metal alloy(s) similar to those of the main body 214. The cover 209 can be connected to the main body 214 by suitable mechanical attachment such as fasteners. The cover 209 can be configured to receive the parts of the upper filter support assembly.

The outlet manifold 208 can couple to the outer housing 204 so as to be in close proximity to but spaced from the coalescing filter 207. The inner housing 206 can be positioned within the outer housing 204 and can be sealed thereto. The inner housing 206 can comprise a sleeve having a hollow construction forming an inner cavity 240 for receiving the coalescing filter 207.

As shown in FIG. 5, the outlet manifold 208, specifically the main body 214, can form a cavity (manifold) 242 internally. The cavity 242 can be in fluid communication with the one or more ports 216 for outflow of blow-by gas after being filtered by the coalescing filter 207. The outlet manifold 208, in particular the main body 214, can include a central port that is part of the cavity 242 that allows for passage of the coalescing filter 207 into the inner cavity 240 of the inner housing 206. The cover 209 (FIG. 5) can be configured to couple with the main body 214 and can be sealed thereto with the seal 238 as further illustrated and discussed subsequently.

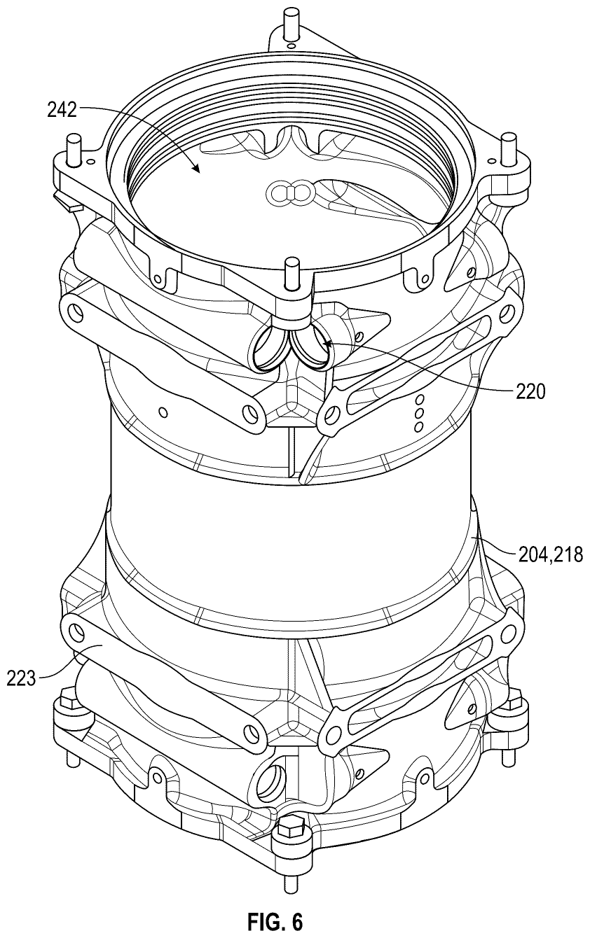

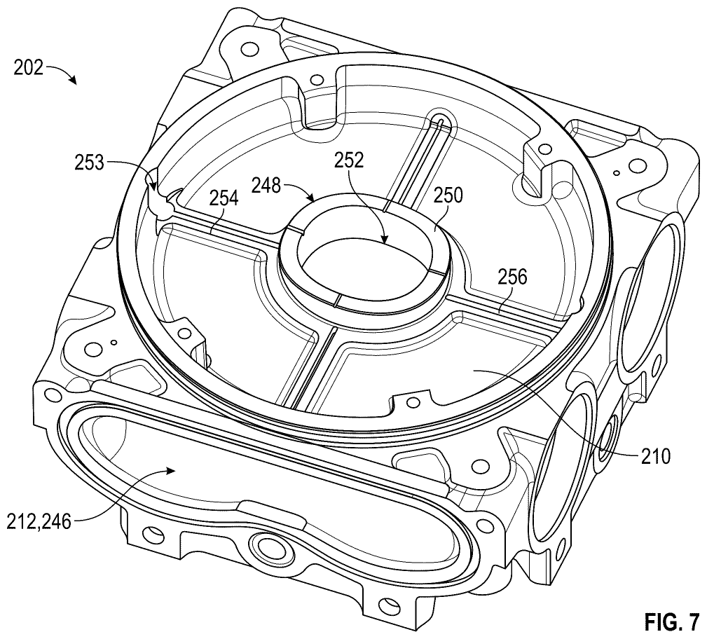

FIG. 6 is a perspective view of the outer housing 204. The housing 204 can have a hollow tubular shape, for example. This shape can form the inner cavity 242 configured to receive the inner housing 206 (FIG. 5). Thus, the inner housing 206 (FIG. 5) can be positioned within the outer housing 204. The outer housing 204 can be constructed of suitable material(s). The outer housing 204 can additionally include the wall 218, the ports 220 and the flanges 223 as discussed previously.

FIG. 7 is a perspective view particularly illustrating a top of the inlet manifold 202. The inlet manifold 202 can include the main body 210 and the one or more ports 212 as discussed previously. The inlet manifold 202 can additionally include a lower cavity 246 and a lower filter support 248. The lower filter support 248 can include a filter interface 250 with a port 252, oil drainage passageway 253, ridges 254 and reliefs such as grooves 256.

The lower cavity 246 can be defined by the main body 210 and can have the one or more ports 212 as inlets (or outlets) and the port 252 as an inlet or outlet thereto. The main body 210 can form an upper wall of the inlet manifold 202 and the lower filter support 248 can be positioned along a top of the inlet manifold 202. The filter interface 250 can be a centralized projection extending above the upper wall of the main body 210. The filter interface 250 can form the port 252. The ridges 254 can projection from the upper wall of the main body 210. The oil drainage passageway 253 can be located in multiple locations on the inlet manifold 202 such as near an outer edge of a plurality of the ridges 254. The oil drainage passageway 253 can be located adjacent the outer side(s) of the inlet manifold 202. The ridges 254 can extend outward away from the filter interface 250 in several directions toward outer sides of the inlet manifold 202. The filter interface 250 and/or the ridges 254 can include the grooves 256 extending there along.

The inlet manifold 202 is configured to allow for fluid communication between the lower cavity 246 and a central cavity of the coalescing filter 207 (FIG. 5) as further discussed and illustrated. In particular, blow-by gas can enter the lower cavity 246 from any direction via the one or more ports 212 defined by the main body 210. The blow-by gas can pass from the lower cavity 246 through the lower filter support 248 via the port 252 to the coalescing filter 207.

The filter interface 250 can have a non-circular shape in cross-section. This non-circular shape can be an oval, elliptical, oblong, square, rectangular, pentagon, quadrilateral, hexagon, octagon, etc. As a result of the non-circular shape of the filter interface 250, the port 252 can be non-circular (e.g., oval, elliptical, oblong, square, rectangular, pentagon, quadrilateral, hexagon, octagon, etc.). Although the filter interface 250 is shown as a feature of the inlet manifold 202 in FIG. 7, according to other examples the filter interface 250 can be a dedicated separate component (e.g., an adapter) configured to be coupled to the inlet manifold 202. The filter interface 250 can be attachable and removable from the inlet manifold 202 according to some examples.

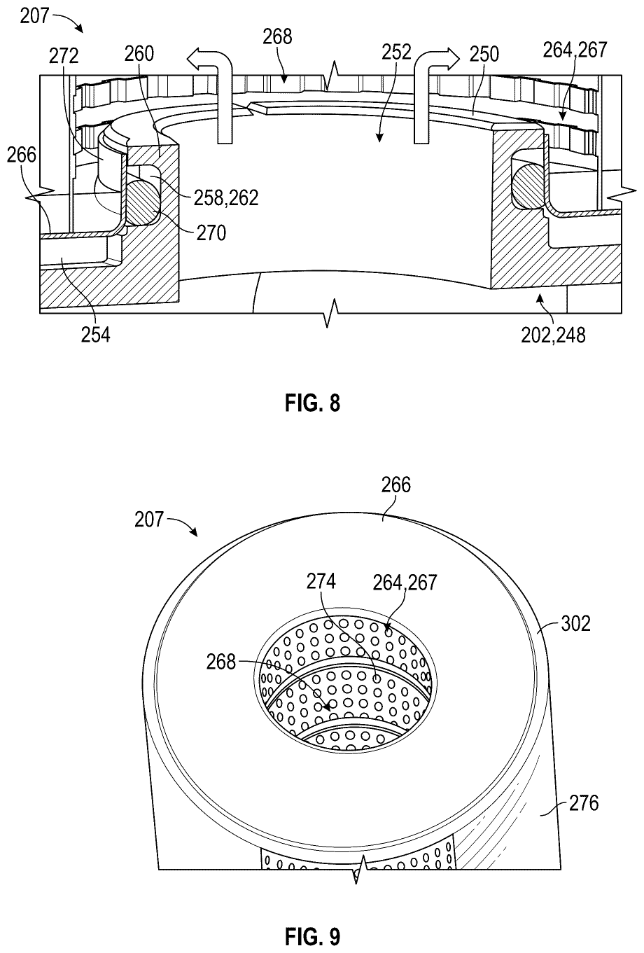

FIG. 8 shows the inlet manifold 202, in particular the lower filter support 248, interfacing with and coupled to a lower part of the coalescing filter 207. The ridges 254 can act as stops (stand offs from the remainder of the inlet manifold 202) for a lower end cap 266 of the coalescing filter 207. The ridges 254 can position the coalescing filter 207 a desired distance from the remainder of the inlet manifold 202 such that the filter interface 250 is inserted a desired distance into the aperture 264 of the lower end cap 266. FIG. 8 shows the filter interface 250 inserted in and received by an aperture 264 of the lower end cap 266 of the coalescing filter 207. The aperture 264 can comprise an inlet port 267 communicating with a central cavity 268 of the coalescing filter 207.

A seal 270 can be received by the groove 262 at the outer side 258. The seal 270 can be an O-ring or other suitable seal construct, for example. The seal 270 can be captured by the lip 260 and a flange 272 of the lower end cap 266. The seal 270 can provide for a sealing interface between the inlet manifold 202 (the filter interface 250) and the coalescing filter 207. FIG. 8 illustrates as yet unfiltered blow-by gas passing through the port 252 of the filter interface 250 and being received by the inlet port 267 and the central cavity 268 of the coalescing filter 207. Due to the non-circular shapes of the filter interface 250 and the aperture 264 (see FIG. 9), the filter interface 250 (a projecting feature) when received in the aperture 264 constrains a rotation of the coalescing filter 207 relative to the housing (e.g., relative to the outer housing 204, the inner housing 206, the outlet manifold 208, and/or the cover 209, etc.).

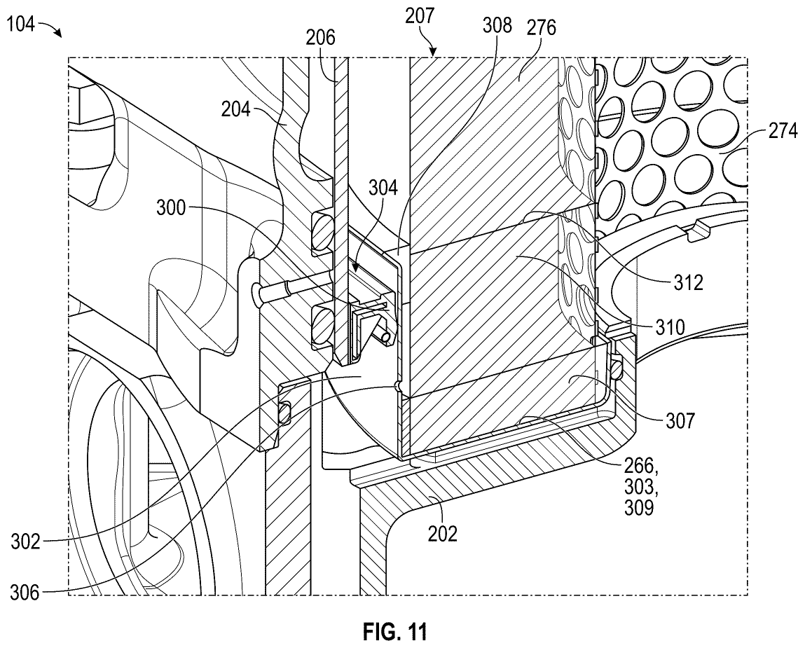

FIG. 9 shows the lower portion of the coalescing filter 207 including the lower end cap 266 having a flange 302 along an exterior surface and with the aperture 264 forming the inlet port 267, the central cavity 268, a core 274 and a filter media 276. As shown in FIG. 9, the aperture 264 defined by the lower end cap 266 can have a non-circular shape corresponding generally to that of the filter interface 250. Thus, the aperture 264 can be oval, elliptical, oblong, square, rectangular, pentagon, quadrilateral, hexagon, octagon, etc. in cross-section. The central cavity 268 can be circular or non-circular in cross-section. The central cavity 268 can be defined by the core 274. The coalescing filter 207 can have a generally cylindrical shape about the central cavity 268 and the core 274. The core 274 can be positioned within the filter media 276. The core 274 can comprise a thin formed cylindrical sheet having a plurality of apertures therein. These apertures communicate with the filter media 276. The coalescing filter 207 is configured to separate a portion of the oil contained in the blow-by gas. The coalescing filter 207 can be constructed using a single or multi-layer synthetic micro-glass fiber, synthetic fiber, or other coalescing filter media types known in the industry with the filter media 276 formed into a tube shape, wound around the core 274, or pleated and located around the core 274. The filter media 276 can be configured for coalescing of oil from oil mist of the blow-by gas. In addition to the filter media 276, the coalescing filter 207 can also include end caps such as the lower end cap 266 and an upper end cap (not shown). The end caps can be constructed of a thin sheet of rigid material that is bonded or otherwise coupled to the core 274 and/or the filter media 276. The material can be metal, metal alloy(s), suitable rigid and stable polymer or composites thereof. The coalescing filter 207 can be sealed to the overall housing with suitable associated seals. However, in some examples, the seal(s) are not provided pre-coupled to the coalescing filter 207 but are rather separate components insertable in the housing or are components of the housing. The core 274 and the filter media 276 can have an inner and outer perforated tube structure to provide the axial, torsional, and bending stiffness required for the application. Such stiffness can be reinforced by the end caps. Example constructions for the flange 302 will be discussed in further detail subsequently with regard to FIGS. 11-21.

FIG. 10 shows a cross-sectional view of the oil separation device 104. FIG. 10 shows the inlet manifold 202, the outer housing 204, the inner housing 206, the coalescing filter 207 including the lower end cap 266, the outlet manifold 208, the cover 209, the lower filter support 248 including the filter interface 250 as previously discussed. FIG. 10 additionally shows the upper filter support assembly 224 and an upper end cap 278. The upper end cap 278 can generally oppose the lower end cap 266 on a second axial end of the coalescing filter 207. Further components of the upper filter support assembly 224 are discussed in a regard to FIG. 10A.

Referring to FIG. 10, the inlet manifold 202 can receive blow-by gas containing oil. This blow-by gas can be passed through the filter interface 250 and into the coalescing filter 207 as previously discussed. The blow-by gas containing oil can pass radially outward through the coalescing filter 207 to an outer circumference thereof. During such passage, the configuration of the coalescing filter 207 can cause coalescing of the oil from the blow-by gas. Such coalescing can result in separation of the oil from the blow-by gas. The oil once coalesced can travel to the outer circumference of the coalescing filter 207 and can pass to an outer cavity 280 surrounding the outer circumference of the coalescing filter 207. The blow-by gas that is separated from the oil by action of the coalescing filter 207 can pass from the coalescing filter 207 into the outer cavity 280 and can pass from the outer cavity 280 into the outlet manifold 208. The outer cavity 280 can communicate with the outlet manifold 208 around substantially all (100% or 360 degrees), most (60%-99%), a majority (50%-59%), some (25%-49% or part (5%-24%) of the outer circumference of the coalescing filter 207. One or more passages can drain oil from the outer cavity 280 into the inlet manifold 202. The one or more passages can be at least partially formed by the main body 210 of the inlet manifold 202. The one or more passages can have an outlet port(s). This outlet port(s) can be located on one or more of the faces of the main body 210. The one or more passages can be configured to receive the oil captured (separated by action of) by the coalescing filter 207 and can pass the oil as a drainage out of the oil separation device 104 at the outlet port(s).

The jacket 222 is shown in FIG. 10. The jacket 222 can comprise a sealed (from the inner cavity, the blow-by gas, oil and from the coalescing filter 207) cavity formed between an interior side of the wall 218 of the outer housing 204 and an outer surface of the inner housing 206. Thus, the jacket 222 can be formed between the inner housing 206 and the outer housing 204. The jacket 222 can be cylindrically shaped having only the ports 220 for fluid communication. The jacket 222 can be configured to receive one or more of an electrical heater coil, an insulative material, a sealed air gap, or a positive mass flow of pressurized engine boost air, engine coolant, or engine lube oil. More particularly, electrically resistive heating coils can be placed in the jacket 222 so as to provide heating to the inner housing 206 and the coalescing filter 207. This can be useful if the oil separation device 104 is being operated in a cold environment. Alternatively or additionally, insulative material such as foam or the like can be placed in the jacket 222 to provide for insulation of the coalescing filter 207 (and blow-by gas) from a harsh environment. The jacket 222 can also receive in addition or alternative to the heating coil and/or insulation, a fluid that can be used for heating or cooling the coalescing filter 207 (and the blow-by gas). Such fluid can be anyone or combination of a sealed air gap, or a positive mass flow of pressurized engine boost air, engine coolant, or engine lube oil, for example. However, the fluid is not limited to these examples.

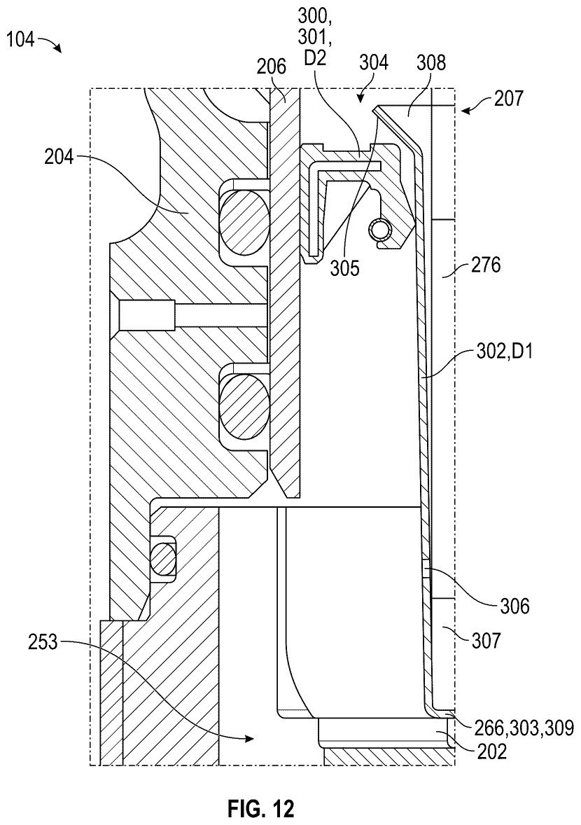

FIGS. 11 and 12 are enlarged cross-sectional views of a lower portion of the oil separation device 104 including the inlet manifold 202, the outer housing 204 and the inner housing 206 and a lower portion of the coalescing filter 207 including a portion of the lower end cap 266, the core 274 (shown in FIG. 11 only) and the filter media 276. FIGS. 11 and 12 additionally illustrate a baffle 300, a flange 302 and a seal assembly 304 formed between the baffle 300 and flange 302. The flange 302 can include a plurality of holes 306. The coalescing filter 207 in addition to the lower end cap 266 with the flange 302 can include a first end 303, a first sealant 307, a second sealant 308, a coalesced oil saturated area 310 (shown in FIG. 11 only) and an oil wet line 312 (shown in FIG. 11 only). The lower end cap 266 in addition to the flange 302 can include the flange 302 and an end portion 309.

The baffle 300 can be positioned in a manifold formed by the housing (e.g., the outer housing 204, the inner housing 206, the inlet manifold 202, and/or another component) that contains the coalescing filter 207. Thus, the baffle 300 can be positioned within the cavity (the manifold) of the inner housing 206 according to the example of FIGS. 11 and 12. However, other examples contemplate different positions for the baffle 300 as further discussed and illustrated herein. The baffle 300 can extend radially inward to engage the flange 302 or another portion of the coalescing filter 207 (see further examples of engagement locations). As shown in FIG. 12 specifically, the baffle 300 can be located an axial distance D2 from the first end 303 of the coalescing filter 207.

The baffle 300 is coupled to the housing (here in this example the inner housing 206) within the inner cavity. The baffle 300 can be formed (integral) with the housing, can be joined thereto using known mechanical connection (e.g., welding, soldering, brazing, chemical bonding, use of fasteners such as rivets, etc.). According to other examples, the baffle 300 can be press-fit to the housing or can utilize another known mechanical or chemical joining technique.

Referring to FIG. 12, the baffle 300 can be configured as an axle seal 301 (FIG. 12) according to some examples. Thus, the baffle 300 can have an outer metal casing coupled to the housing 206, sealing lip(s) that contact the flange 302 forming the sealing assembly 304 and a garter spring. The sealing lip(s) can make direct contact with the flange 302. The sealing lip(s) can be made from high-performance elastomer(s). Common materials for the sealing lip(s) can include, but are not limited to, NBR (nitrile rubber), Viton, PTFE (polytetrafluoroethylene), HNBR (hydrogenated nitrile), EPDM, or silicone. The garter spring can be configured to maintain consistent pressure of the sealing lip(s) against the flange 302, ensuring a tight seal.

As shown in FIGS. 11 and 12, the baffle 300 engages an exterior surface (e.g., the flange 302) of the coalescing filter 207 at a first distance (here distance D2 in the example of FIG. 12) between the first end 303 and a second end (not shown) of the coalescing filter 207 to form the seal assembly 304 therewith.

The flange 302 is a portion of the lower end cap 266. The flange 302 can have an elongate axial length extending a distance D1 (FIG. 12) along a curved outer surface of the coalescing filter 207 from the first end 303 and the end portion 309 of the lower end cap 266. The flange 302 can form a portion of the outer surface of the coalescing filter 207. The distance D1 can be between about 10% and about 15%, for example. The distance D2 can be less than the distance D1. However, other distances for D1 are contemplated. The lower end cap 266, and hence, the flange 302 can be constructed of suitable materials such as metal alloy, injection molded plastic, etc.

As shown in FIG. 12, the flange 302 can have the plurality of holes 306 therethrough. The plurality of holes 306 can be between 3 mm in diameter and 6 mm in diameter, for example. The plurality of holes 306 can be arranged around the circumference of the coalescing filter 207 in spaced apart intervals. The number of the plurality of holes 306 can be between 4 and 32, for example. However, other sizes for the plurality of holes 306 and other numbers for the plurality of holes 306 are contemplated. The plurality of holes 306 can be located axially a distance above the innermost extent of the first sealant 307 and above the first end 303. The plurality of holes 306 can be configured to pass coalesced oil (captured in the filter media 276 in the coalesced oil saturated area 310 shown in FIG. 11) as a weep. The plurality of holes 306 are positioned between the seal assembly 304 and the first sealant 307 (a bonded sealant) that affixes the first end cap 266 to the filter media 276 at the first end 303. The plurality of holes 306 can be sized and/or numbered to allow the coalesced oil to drain as the weep while preventing a vacuum pressure from drawing the coalesced oil in an undesired direction past the seal assembly 304 and toward the second end of the coalescing filter. The coalesced oil can drain under gravity and can pass through the plurality of holes 306 from the filter media 276 to the oil drainage passageway 253.

The flange 302 can extend axially along an outer surface of the filter media 276 extending from the end portion 309. The flange 302 can be tapered as shown in FIG. 12. The taper can be such that a diameter of the coalescing filter 207 increases moving axially away from the first end 303. The flange 302 can be tapered to facilitate a progressive engagement between the baffle 300 and the exterior surface (formed by exterior surface of the flange 302 in this example) during insertion of the coalescing filter 207 into the inner cavity. The portion of the flange 302 contacted by the baffle 300 can be relatively smooth such as to form a journal surface for sealing, for example. The flange 302 can have a flared portion 305 at an outermost end portion. This flared portion 305 of greater diametric extent. The flared portion 305 can be an axial-most portion of the flange 302 toward the second end (not shown) of the coalescing filter 207. The flange 302 can be bonded to the filter media with the second sealant 308. This second sealant 308 can be backfilled to fill a volume between the flange 302 and the filter media 276. This volume (space) results from the taper of the flange 302 and the flared portion 305.

As shown in FIGS. 11 and 12, the flange 302 forms a portion of the exterior surface of the coalescing filter 207 that engages with the baffle 300. The flange 302 can extend axially a distance (distance D1 in FIG. 12) that is at least 80% of the wet line 312 (FIG. 11) for coalesced oil captured by the filter media 276. However, other extents for the flange 302 are contemplated including extending axially to at least 100%, 110%, 120% or more of the wet line 312 (FIG. 11).

The end cap 266, particularly, the entirety of the end portion 309 and a lower portion of the flange 302 can be bonded to the filter media 276 by the first sealant 307. This first sealant 307 and indeed the second sealant 308 can be a bonding adhesive such as urethane or other suitable material.

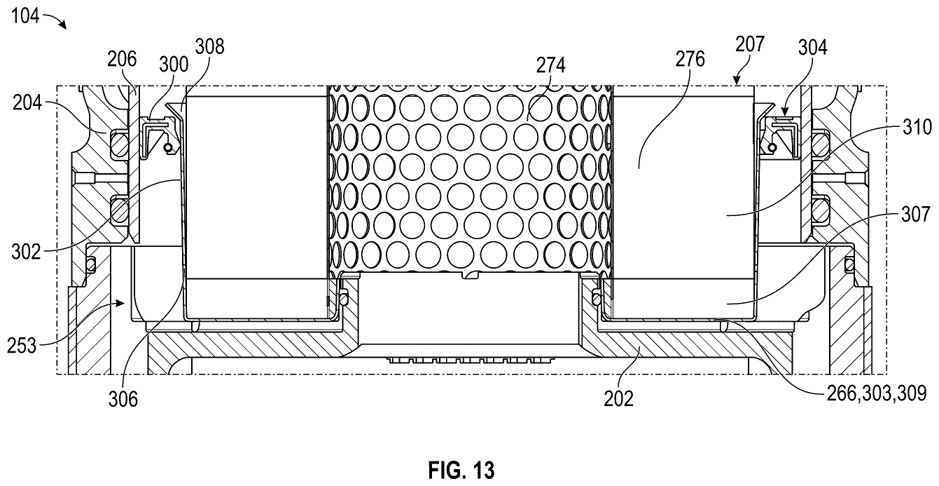

FIG. 13 is a cross-section that shows further parts of the lower portion of the oil separation device 104 including the inlet manifold 202, the outer housing 204, the inner housing 206, the oil drainage passageway 253 and the entire lower portion of the coalescing filter 207 including the lower end cap 266, the core 274 and the filter media 276. FIG. 13 also shows the baffle 300, the flange 302, the first end 303, the seal assembly 304, the plurality of holes 306, the first sealant 307, the second sealant 308 and the end portion 309 of the end cap 266 as previously discussed.

As shown in FIG. 13, the baffle 300 is a perimeter baffle that forms part of the seal assembly 304. The seal assembly 304 is a ring shaped seal positioned within the housing (here the inner housing 206 but can be located within other parts of the housing according to further examples). The baffle 300 engages with, encloses and seals a portion of the oil coalescing filter 207 along a perimeter thereof. The portion of the coalescing filter 207 that is enclosed and sealed can include portions of the lower end cap 266, particularly the end portion 309 and some lower portions of the flange 302 (e.g., portions that form the plurality of holes 306). The seal assembly 304 is formed by the baffle 300 that interfaces with and contacts the oil coalescing filter 207 on a curved exterior surface thereof.

The baffle 300 can be a permanent feature of the housing along an inner manifold that receives and houses the oil coalescing filter 207. As discussed previously, the seal assembly 304 can be positioned at around or greater than 80% of the filter wet line (below the filter wet line the filter media 276 is saturated with coalesced oil). The seal assembly 304 blocks a radial gap between the exterior surface of the oil coalescing filter 207 and the inner surface (here formed by the inner surface of the inner housing 206) of the housing.

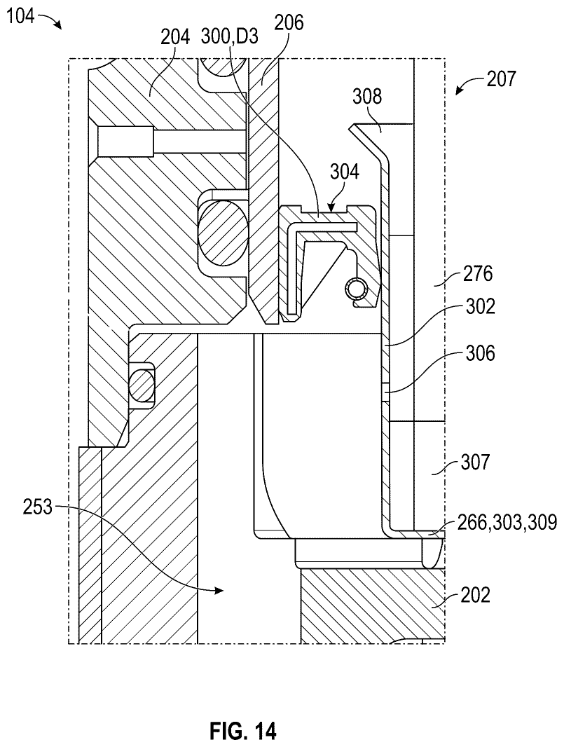

FIG. 14 is an enlarged cross-sectional view of a lower portion of the oil separation device 104 including the inlet manifold 202, the outer housing 204, the inner housing 206 and the oil drainage passageway 253 and a lower portion of the coalescing filter 207 including the lower end cap 266 and the filter media 276. FIG. 14 additionally illustrates the baffle 300, the flange 302 and the seal assembly 304 formed between the baffle 300 and flange 302. The flange 302 can include the plurality of holes 306. The coalescing filter 207 in addition to the lower end cap 266 with the flange 302 can include the first end 303, the first sealant 307 and the second sealant 308. The lower end cap 266 can include the flange 302 and the end portion 309.

FIG. 14 shows a cross-sectional view of an example similar to FIG. 12 but with the position of the baffle 300 and the seal assembly 304 moved a distance D3, which places the baffle 300 and the seal assembly 304 is relatively closer to the first end 303 and the end portion 309 of the lower end cap 266. This distance D3 is relatively closer than distance D2 in the example of FIG. 12. The baffle 300 is now coupled to a distalmost end of the inner housing 206 and is spaced relatively closer to the plurality of holes 306 and relatively further away from the second sealant 308 and the axial end of the flange 302.

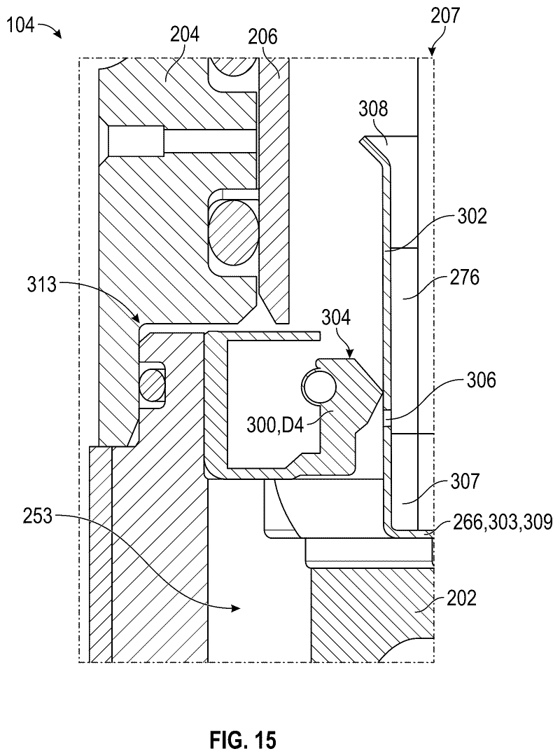

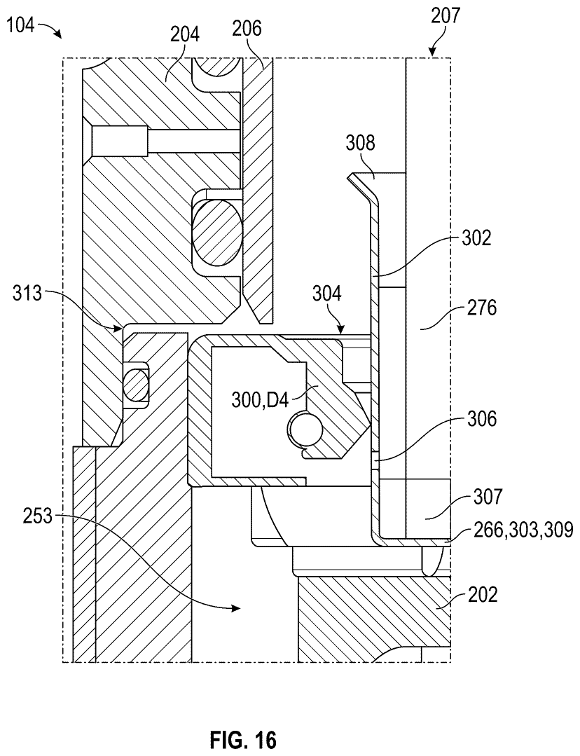

FIGS. 15 and 16 are enlarged cross-sectional views of a lower portion of the oil separation device 104 including the inlet manifold 202, the outer housing 204, the inner housing 206 and the oil drainage passageway 253 and a lower portion of the coalescing filter 207 including the lower end cap 266 and the filter media 276. FIGS. 14 and 15 additionally illustrate the baffle 300, the flange 302 and the seal assembly 304 formed between the baffle 300 and flange 302. The flange 302 can include the plurality of holes 306. The coalescing filter 207 in addition to the lower end cap 266 (with the flange 302) can include the first end 303, the first sealant 307 and the second sealant 308. The lower end cap 266 can include the flange 302 and the end portion 309.

FIGS. 15 and 16 show cross-sectional views and examples similar to FIGS. 12 and 13 but the position of the baffle 300 and the seal assembly 304 are moved a distance D4, which is relatively closer to the first end 303 and the end portion 309 of the lower end cap 266 than distance D2 in the example of FIG. 12 or the distance D3 in the example of FIG. 14. The baffle 300 is now coupled to the inlet manifold 202 in a groove 313 between the inlet manifold 202 and the outer housing 204 and is spaced relatively closer to the plurality of holes 306 and relatively further away from the second sealant 308 and the axial end of the flange 302. FIG. 16 shows the orientation of the baffle 300 inverted (reversed) from the orientation of FIG. 15.

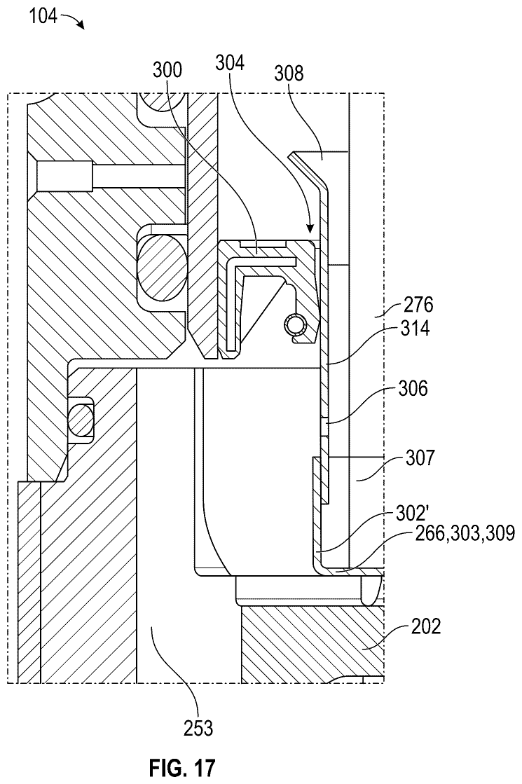

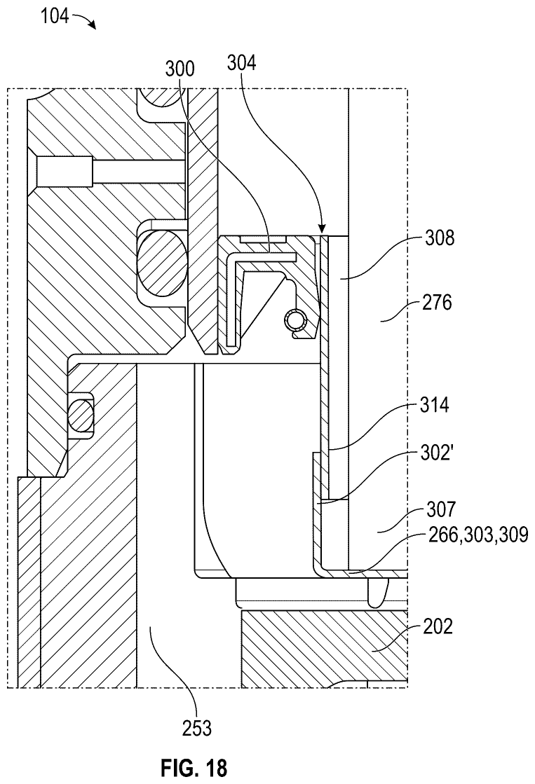

FIGS. 17 and 18 are enlarged cross-sectional views of a lower portion of the oil separation device 104 including the inlet manifold 202, the outer housing 204, the inner housing 206 and the oil drainage passageway 253 and a lower portion of the coalescing filter 207 including the lower end cap 266 and the filter media 276. FIGS. 17 and 18 additionally illustrate the baffle 300, a flange 302′ and the seal assembly 304 formed between the baffle 300 and the flange 302′. A sleeve 314 rather than the flange 302′ can include the plurality of holes 306 (shown only in the cross-section of FIG. 17 but also present but not shown in the example of FIG. 18). The coalescing filter 207 in addition to the sleeve 314 and the flange 302′ can include the first end 303, the first sealant 307 and the second sealant 308. The lower end cap 266 can include the flange 302′ and the end portion 309.

FIGS. 17 and 18 show cross-sectional views and an example similar to FIG. 14 but the coalescing filter 207 now includes a sleeve 314 that forms a sealing surface with the baffle 300 along an exterior surface of the coalescing filter 207. Thus, the seal assembly 304 is formed between the baffle 300 and the sleeve 314. An axial extent (length) of the flange 302′ has been reduced relative to prior examples of flange from FIGS. 11-16. The sleeve 314 that forms the exterior surface of the coalescing filter 207 can form the plurality of holes 306 and the sleeve 314 can be backfilled or otherwise coupled to the filter media 276 with the second sealant 308 in a manner similar to the flange of previous examples. The example of FIG. 17 differs from FIG. 18 in that the sleeve 314 does not include a flared axial end portion in FIG. 18.

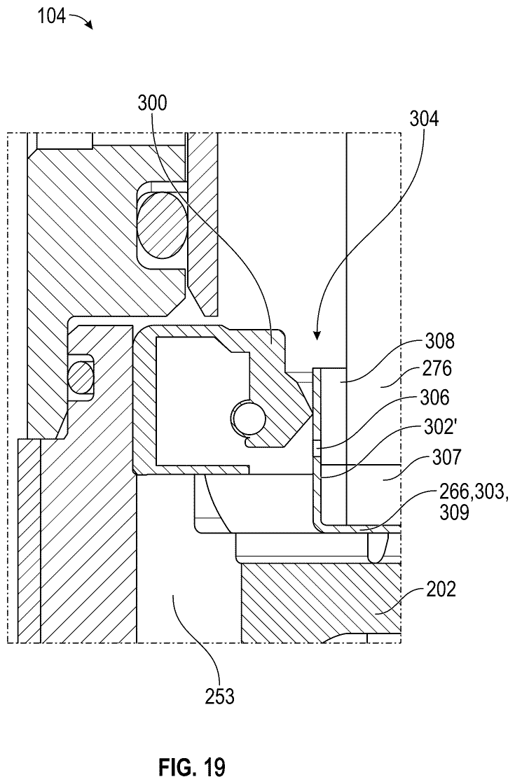

FIG. 19 is enlarged cross-sectional view of a lower portion of the oil separation device 104 including the inlet manifold 202, the outer housing 204, the inner housing 206 and the oil drainage passageway 253 and a lower portion of the coalescing filter 207 including the lower end cap 266 and the filter media 276. FIG. 19 additionally illustrates the baffle 300, the flange 302′ and the seal assembly 304 formed between the baffle 300 and flange 302′. The flange 302′ can include the plurality of holes 306. The coalescing filter 207, in addition to the lower end cap 266 with the flange 302′, can include the first end 303, the first sealant 307 and the second sealant 308. The lower end cap 266 can include the flange 302 and the end portion 309.

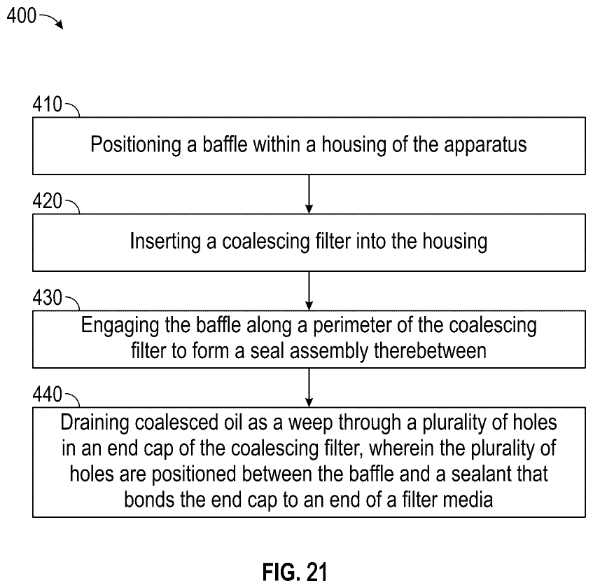

FIG. 19 shows a cross-sectional view with an example similar to FIGS. 15 and 16 in terms of the position of the baffle 300. However, the baffle 300 interacts with an axially shortened distance of the flange 302′ (as compared with the extended axial distance of the flange shown in some of the prior examples) The interaction of the flange 302′ with the baffle 300 forms the seal assembly 304 only a small distance from the plurality of holes 306. The example of FIG. 21 utilizes only a relatively small amount of the second sealant 308 due to the shortened length of the flange 302′.

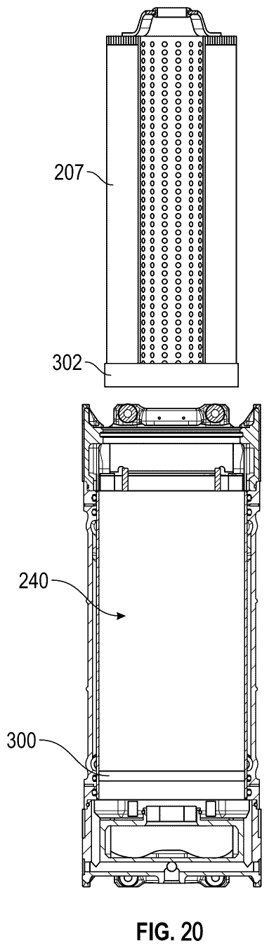

FIG. 19 illustrates the coalescing filter 207 removed from but configured to be insertable in a housing (one or more parts of the oil separation device 104 other than the coalescing filter 207). FIG. 20 illustrates the baffle 300 that is part of the housing within the inner cavity 240 and the flange 302 that is part of the end cap as previously discussed. As discussed previously, the baffle 300 can be configured to form a perimeter seal with the coalescing filter 207 such as by having the baffle 300 engage with the flange 302 or another portion of an exterior surface of the coalescing filter 207 spaced a distance between a first end of the coalescing filter 207 and a second end of the coalescing filter 207.

FIG. 21 is a flowchart of an example method 400 of preventing bypass flow in an apparatus for separating oil from a blow-by gas of an engine. The method 400 can include at step 410 positioning a baffle within a housing of the apparatus (see e.g., FIG. 20 or certain other FIGURES herein). At step 420, the method 400 can include inserting the coalescing filter into the housing. The method 400 can include engaging 430 the baffle along a perimeter of the coalescing filter to form a seal assembly therebetween. The method 400 can include draining 440 coalesced oil as a weep through a plurality of holes in an end cap of the coalescing filter, The plurality of holes can be positioned between the baffle and a sealant that bonds the end cap to an end of a filter media. The plurality of holes can be sized to allow coalesced oil flow as the weep while preventing a vacuum pressure from drawing the coalesced oil in an undesired direction past the seal assembly.

The method 400 optionally can include that the baffle engages a flange of the end cap to form the seal assembly. The method 400 can further include bonding the flange of the coalescing filter to the filter media with a thixotropic adhesive that is backfilled between the flange and the filter media.

### INDUSTRIAL APPLICABILITY

In operation, the engine 100 can be configured to combust fuel to generate power. While typically efficient, a small portion of the combustion gases may escape the combustion chamber past the piston as blow-by and enter undesirable areas of the engine 100 such as the crankcase. The present disclosure contemplates a system 102 including one or more oil separation devices 104 to filter oil to remove the oil from the blow-by gas.

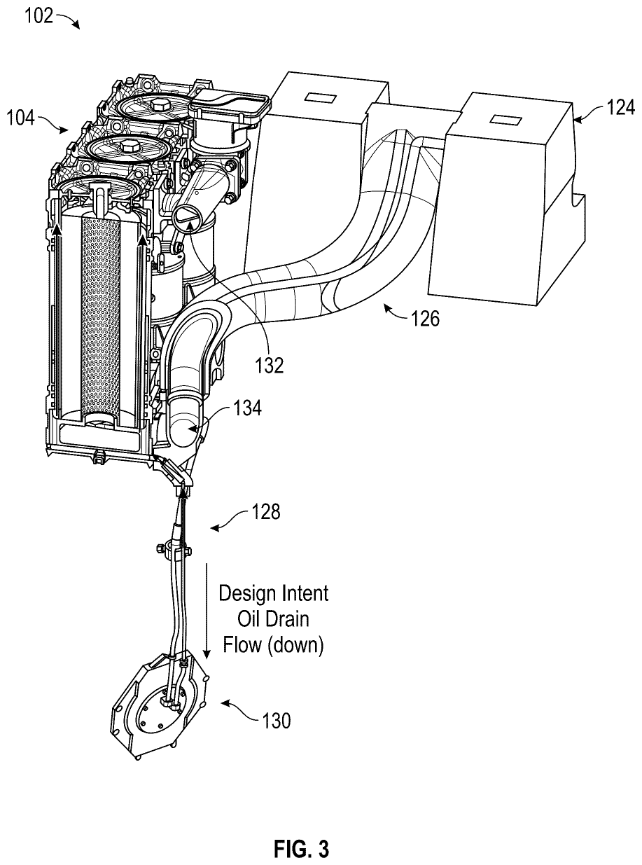

Oil separation devices 104 containing coalescing filters 207 are disclosed. For proper long-term engine operation, the coalesced oil must be drained away from the coalescing filter 207 contained within the oil separation devices 104. Typically, this is accomplished using a gravity oil drain line such as the oil drain line 128 of FIG. 2 that routes from the bottom of the oil separation device(s) 104 down to either the engine crankcase (above oil level) or the oil sump (below oil level). However, in rare instances, failures can occur within the oil drain line. An example of a failure is shown in FIG. 3, which shows various components previously discussed in FIG. 2 such as the oil separation devices 104 and other components of the system 102 such as the crankcase breathers 124, the blow-by inlet line 126, the oil drain line(s) 128 and the crankcase side cover 130.

As shown in FIG. 3, the failure can allow raw blow-by gas or oil to bypass the coalescing filter as indicated by arrows and escape directly to the filter outlet port 132 via the filter inlet port 134 and passage in an undesired reverse direction through the oil separation device 104 (as indicated by arrows) as shown in FIG. 3. These drain system failures can be caused by issues like particulate blockage, leakage combined with vacuum pressure, or other problems.

When oil drain system failures occur, the vacuum pressure acting on the filter outlet port 132 can draw unfiltered blow-by gas up through the oil drain line 128, bypassing the coalescing filters within the oil separation devices 104. This allows the unfiltered blow-by gas to mix with the filtered blow-by gas exiting the coalescing filters and escape through the outlet port 132 as indicated in FIG. 3. The higher oil carryover that results from this bypass can lead to emissions issues and/or engine performance problems, with the specific impacts depending on the crankcase ventilation system architecture (F-OCV, F-CCV, etc.).

The present application particularly the oil separation device 104 discussed herein has various features that address these and other problems. The oil separation device 104 provides for improved sealing via the baffle 300 and the seal assembly 304 discussed herein and the use of flow control features such as the flange 302 with the plurality of holes 306 that reduce pressure differential and prevent unfiltered blow-by gas from bypassing the coalescing filter 207 during oil drain system failures.

Specifically, the oil separation device 104 can include a perimeter baffle (e.g., the baffle 300) that creates a high-pressure differential barrier between the oil drain sub-system and the filter outlet port. The baffle 300 can be ring-shaped and can be positioned within the housing a desired distance from the saturated end of the coalescing filter 207 (e.g., at approximately 80% or greater of the filter wet line 312 (FIG. 11) height). The baffle 300 engages with the exterior surface of the coalescing filter 207 to form the seal assembly 304 that blocks the radial gap between the coalescing filter exterior surface and an inner surface of the housing (e.g., any component that is not the coalescing filter 207).

The coalescing filter 207 can include a modified lower end cap 266 with the extended flange (e.g., the flange 302) that reaches up to or above the filter wet line 312 (FIG. 11). This flange 302 can incorporate carefully sized and positioned weep holes (e.g., the plurality of holes 306) that allow controlled oil drainage while preventing vacuum-induced reverse blow-by/oil flow. The flange 302 can be tapered to facilitate progressive sealing engagement as the coalescing filter 207 is seated into position within the housing, and the coalescing filter 207 can use a thixotropic adhesive (e.g., the second sealant 308) backfilled between the flange 302 and the filter media 276 to create an additional barrier against bypass flow.

Additionally, the configuration of the oil separation device 104 can reduce the vacuum pressure required for proper coalescing filter operation (separation) and oil drainage. While current systems may need 10 kPA vacuum with one meter of head height, the present solution with the plurality of holes 306 can operate with 6-7 kPA vacuum and a reduced head height. This makes the oil separation service 104 particularly beneficial for smaller engine applications that have limited vacuum generation capability.

The oil separation device 104 offers flexible implementation options, as the baffle 300 can be coupled to the housing and can be positioned at different axial locations (e.g., see FIGS. 12-19) along the coalescing filter. These different positions can position the baffle 300 and the seal assembly at different positions relative to the plurality of holes 306. The baffle 300 can be configured to engage with the flange 302, configured to engage with a sleeve 314 or can be configured to directly engage with a sealed filter media surface as shown and discussed. The baffle 300 can be press-fit or otherwise coupled within the housing to prevent any bypass flow past the seal assembly 304. Together, the baffle 300 and the flange 302 (or another feature of the coalescing filter 207) and the plurality of holes 306 create multiple barriers that effectively prevent unfiltered blow-by gas or oil from bypassing the coalescing filter during drain system failures while maintaining proper oil drainage functionality.

The above detailed description is intended to be illustrative, and not restrictive. The scope of the disclosure should, therefore, be determined with references to the appended claims, along with the full scope of equivalents to which such claims are entitled.

What is claimed is:

1. An apparatus for separating oil from a blow-by gas of an engine, comprising:
a housing forming an inner cavity;
a coalescing filter having a first end and a second end, wherein the coalescing filter is received within the inner cavity and configured to separate the oil from the blow-by gas; and
a baffle coupled to the housing within the inner cavity, wherein the baffle engages an exterior surface of the coalescing filter at a first distance between the first end and the second end to form a seal assembly therewith.

2. The apparatus of claim 1, wherein the baffle is ring-shaped and engages around an entirety of a curved perimeter of the exterior surface, wherein the baffle extends between an inner surface of the housing that forms the inner cavity and the curved perimeter of the coalescing filter.

3. The apparatus of claim 1, wherein the coalescing filter includes:
a filter media;
a central core defining a central cavity, the central core positioned within the filter media;
a first end cap coupled to the filter media at the first end, the first end cap having a flange extending axially away from the first end toward the second end and forming a portion of the exterior surface; and
a second end cap coupled to the filter media at the second end from the first end cap;
wherein the flange forms the portion of the exterior surface of the coalescing filter that engages with the baffle.

4. The apparatus of claim 3, wherein the flange extends axially a distance along a curved perimeter of the exterior surface that is at least 80% of a wet line of coalesced oil captured by the filter media.

5. The apparatus of claim 4, wherein the flange has a plurality of holes configured to pass the coalesced oil as a weep, wherein the plurality of holes are positioned between the seal assembly and a bonded sealant that affixes the first end cap to the filter media at the first end.

6. The apparatus of claim 5, wherein the plurality of holes are sized to allow the coalesced oil to drain as the weep while preventing a vacuum pressure from drawing the coalesced oil in an undesired direction past the seal assembly and toward the second end.

7. The apparatus of claim 3, wherein the flange of the first end cap is bonded to the filter media with a sealant that is backfilled to fill a volume between the flange to the filter media.

8. The apparatus of claim 3, wherein the flange is tapered such that a diameter of the coalescing filter increases moving axially away from the first end, wherein the flange is tapered to facilitate a progressive engagement between the baffle and the exterior surface during insertion of the coalescing filter into the inner cavity.

9. The apparatus of claim 1, wherein the exterior surface that engages the baffle is formed by one of: a bonded sealant of a filter media of the coalescing filter, a first end cap or a sleeve that surrounds a portion of the filter media axially between the first end and the second end.

10. The apparatus of claim 1, wherein the baffle is configured as an axle seal having a spring element.

11. An engine system comprising:
an engine; and
an oil separating apparatus, comprising:
a housing forming an inner cavity;
a coalescing filter having a first end and a second end, wherein the coalescing filter is configured to be insertable to be received within the inner cavity and is configured to separate oil from a blow-by gas;
a baffle configured to be positioned in the housing within the inner cavity, wherein the baffle is configured to engage an exterior surface of the coalescing filter at a first distance between the first end and the second end to form a seal assembly therewith;
a first one or more fluid lines passing the blow-by gas from the engine to the oil separating apparatus; and
a second one or more fluid lines passing the blow-by gas from the oil separating apparatus back to the engine.

12. The system of claim 11, wherein the coalescing filter includes:
a filter media;
a central core defining a central cavity, the central core positioned within the filter media;
a first end cap coupled to the filter media at the first end, the first end cap having a flange extending axially away from the first end toward the second end and forming a portion of the exterior surface; and
a second end cap coupled to the filter media at the second end from the first end cap;
wherein the flange forms the portion of the exterior surface of the coalescing filter that engages with the baffle.

13. The system of claim 12, wherein the flange extends axially a distance along a curved perimeter of the exterior surface that is at least 80% of a wet line of a coalesced oil captured by the filter media.

14. The system of claim 12, wherein the flange has a plurality of holes configured to pass a coalesced oil captured by the filter media as a weep, wherein the plurality of holes are positioned between the seal assembly and a bonded sealant that affixes the first end cap to the filter media at the first end.

15. The system of claim 12, wherein the flange of the first end cap is bonded to the filter media with a sealant that is backfilled to fill a volume between the flange to the filter media.

16. A method of preventing bypass flow in an apparatus for separating oil from a blow-by gas of an engine, comprising:
positioning a baffle within a housing of the apparatus;
inserting a coalescing filter into the housing;
engaging the baffle along a perimeter of the coalescing filter to form a seal assembly therebetween; and
draining coalesced oil as a weep through a plurality of holes in an end cap of the coalescing filter, wherein the plurality of holes are positioned between the baffle and a sealant that bonds the end cap to an end of a filter media.

17. The method of claim 16, wherein the baffle engages a flange of the end cap to form the seal assembly.

18. The method of claim 17, further comprising bonding the flange of the coalescing filter to the filter media with a thixotropic adhesive that is backfilled between the flange and the filter media.

19. The method of claim 16, wherein the plurality of holes are sized to allow coalesced oil flow as the weep while preventing a vacuum pressure from drawing the coalesced oil in an undesired direction past the seal assembly.

20. The method of claim 19, wherein the baffle reduces the vacuum pressure required for drainage of the coalesced oil as the weep.
